(19) United States
(12) Patent Application Publication
(10) Pub. No.: US 2010/0028565 A1
(43) Pub. Date: Feb. 4, 2010

(54) Flexible Display Apparatus

(76) Inventors: Ted-Hong SHINN, Hsinchu City (TW); Yi-Ching WANG, Hsinchu City (TW); Yuan-Chih TSAI, Hsinchu City (TW)

Correspondence Address: HDLS Patent & Trademark Services, P.O. BOX 220746, CHANTILLY, VA, 20153-0746, US

(21) Appl. No.: 12/239,954

(22) Filed: Sep. 29, 2008

(30) Foreign Application Priority Data
Jul. 29, 2008 (TW) 097128706

(51) Int. Cl. C09K 19/02; B32B 9/04; B32B 27/06

(52) U.S. Cl. 428/1.1; 428/411.1; 428/339; 428/473.5

(57) ABSTRACT

A flexible display apparatus includes a waterproof layer, an insulation layer and a display unit, wherein the insulation layer is disposed on the waterproof layer and the display unit is disposed on the insulation layer. Furthermore, material of the waterproof layer includes organic compound. The flexible display apparatus has better reliability.

### BACKGROUND

1. Field of the Invention

The present invention relates to a display apparatus, and particularly to a flexible display apparatus.

2. Description of the Related Art

With progress of the flat display technique, more and more electrical products, especially portable electrical products such as mobile phones, e-books, digital cameras and personal digital assistants etc., are equipped with flat display apparatuses. The development trend of the portable electrical product is achieving light weight and thin thickness, so the flat display apparatus for the portable electrical product should have features of light weight and thin thickness.

The flexible display apparatus, such as the flexible electrophoretic display (EPD) and the flexible liquid crystal display (LCD) etc., not only has features of light weight and thin thickness, but also has features of flexibility and hard to be broken. Therefore, the development of the flexible display apparatus has become increasingly important.

The substrate of the general flat display apparatus is a glass substrate, but in the flexible display apparatus, the glass substrate is replaced by a plastic substrate. The glass substrate has good effect of water proofing but the effect of water proofing of the plastic substrate is poor. Therefore, steam is easy to permeate into the flexible display apparatus from the plastic substrate and thus circuits and devices of the flexible display apparatus may be damaged. In other words, reliability of the conventional flexible display apparatus is poor.

### BRIEF SUMMARY

The present invention relates to a flexible display apparatus having better reliability.

To achieve the above-mentioned advantages, the present invention provides a flexible display apparatus. The flexible display apparatus includes a waterproof layer, an insulation layer and a display unit, wherein the insulation layer is disposed on the waterproof layer and the display unit is disposed on the insulation layer. Furthermore, material of the waterproof layer includes organic compound.

In an embodiment of the present invention, the material of the waterproof layer comprises polyetheretherketone (PEEK).

In an embodiment of the present invention, the waterproof layer is formed by casting method.

In an embodiment of the present invention, thickness of the waterproof layer is between 20 micrometers and 500 micrometers.

In an embodiment of the present invention, steam permeability of the waterproof layer is lower than 15%/meter square/day under 23 degrees centigrade and 100% relative humidity.

In an embodiment of the present invention, the flexible display apparatus further includes a plastic substrate disposed between the waterproof layer and the insulation layer, or disposed below the waterproof layer.

In an embodiment of the present invention, wherein material of the plastic substrate comprises polyimide.

In an embodiment of the present invention, the display unit includes a circuit structure layer, a display medium layer and a transparent layer. The circuit structure layer is disposed on the insulation layer, the display medium layer is disposed on the circuit structure layer, and the transparent layer is disposed on the display medium layer.

In an embodiment of the present invention, the display medium layer is an electrophoretic layer or a liquid crystal layer.

The present invention further provides a flexible display apparatus. The flexible display apparatus includes a waterproof layer, an insulation layer and a display unit, wherein the insulation layer is disposed on the waterproof layer, and the display unit is disposed on the insulation layer. Furthermore, thickness of the waterproof layer is between 20 micrometers and 500 micrometers.

In an embodiment of the present invention, steam permeability of the waterproof layer is lower than 15%/meter square/day under 23 degrees centigrade and 100% relative humidity.

In an embodiment of the present invention, the flexible display apparatus further includes a plastic substrate disposed between the waterproof layer and the insulation layer, or disposed below the waterproof layer.

In an embodiment of the present invention, material of the plastic substrate comprises polyimide.

In an embodiment of the present invention, the display unit includes a circuit structure layer, a display medium layer and a transparent layer. The circuit structure layer is disposed on the insulation layer, the display medium layer is disposed on the circuit structure layer, and the transparent layer is disposed on the display medium layer.

In an embodiment of the present invention, the display medium layer is an electrophoretic layer or a liquid crystal layer.

The present invention further provides a flexible display apparatus. The flexible display apparatus includes a waterproof layer, an insulation layer and a display unit, wherein the insulation layer is disposed on the waterproof layer, the display unit is disposed on the insulation layer. Furthermore, steam permeability of the waterproof layer is lower than 15%/meter square/day under 23 degrees centigrade and 100% relative humidity.

In an embodiment of the present invention, the flexible display apparatus further includes a plastic substrate disposed between the waterproof layer and the insulation layer, or disposed below the waterproof layer.

In an embodiment of the present invention, material of the plastic substrate comprises polyimide.

In an embodiment of the present invention, the display unit includes a circuit structure layer, a display medium layer and a transparent layer. The circuit structure layer is disposed on the insulation layer, the display medium layer is disposed on the circuit structure layer, and the transparent layer is disposed on the display medium layer.

In an embodiment of the present invention, the display medium layer is an electrophoretic layer or a liquid crystal layer.

The flexible display apparatus of the present invention has the waterproof layer which can prevent steam from permeating into the flexible display apparatus, so damage of circuits and devices of the flexible display apparatus is avoided. Therefore, the flexible display apparatus of the present invention has better reliability.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view of a flexible display apparatus according to an embodiment of the present invention.

FIG. 2 is a schematic view of a flexible display apparatus according to another embodiment of the present invention.

FIG. 3 is a schematic view of a flexible display apparatus according to another embodiment of the present invention.

### DETAILED DESCRIPTION

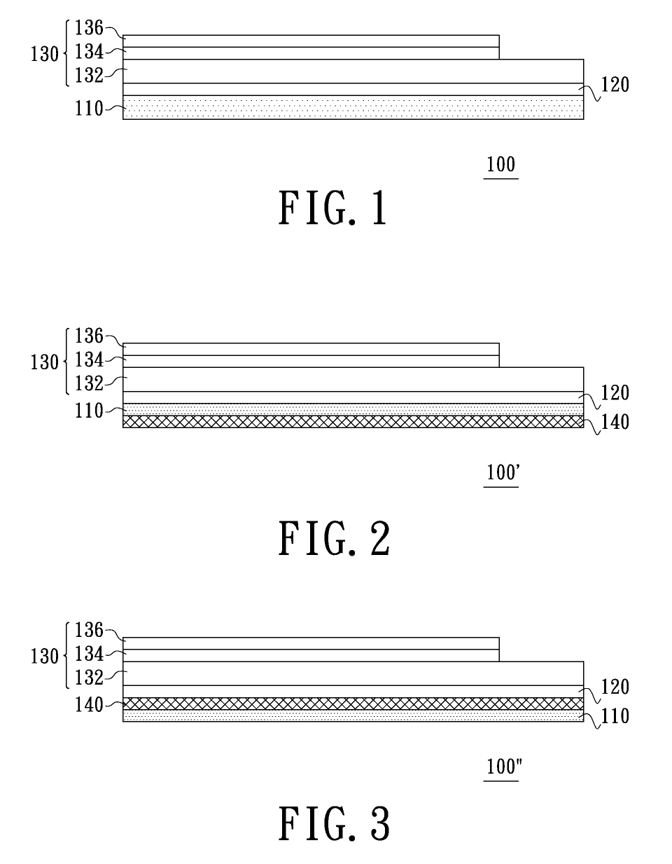

FIG. 1 is a schematic view of a flexible display apparatus according to an embodiment of the present invention. Referring to FIG. 1, the flexible display apparatus 100 of the present embodiment includes a waterproof layer 110, an insulation layer 120 and a display unit 130, wherein the insulation layer 120 is disposed on the waterproof layer 110 and the display unit 130 is disposed on the insulation layer 120.

In the flexible display apparatus 100, the waterproof layer 110 satisfies at least one of the three following conditions:

1. Material of the waterproof layer 110 includes organic compound.

2. Thickness of the waterproof layer 110 is between 20 micrometers and 500 micrometers.

3. Steam permeability of the waterproof layer 110 is lower than 15%/meter square/day under 23 degrees centigrade and 100% relative humidity.

The organic compound can be PEEK. In the embodiment of the material of the waterproof layer 110 being the PEEK, the waterproof layer 110 can be formed by casting method. The casting method can effectively control the size of the waterproof layer under high temperature condition, so the size of the waterproof layer 110 is stable.

The display unit 130 includes a circuit structure layer 132, a display medium layer 134 and a transparent layer 136, wherein the circuit structure layer 132 is disposed on the insulation layer 120, the display medium layer 134 is disposed on the circuit structure layer 132, and the transparent layer 136 is disposed on the display medium layer 134. Moreover, the display medium layer 134 can be an electrophoretic layer or a liquid crystal layer. In other words, the flexible display apparatus 100 can be a flexible EPD or a flexible LCD.

Furthermore, the circuit structure layer 132 includes, for example, an active matrix and a peripheral circuit. In the embodiment of the flexible display apparatus 100 being the flexible LCD, the display medium layer 134 is a liquid crystal layer. When the circuit structure layer 132 includes a color filter film, the transparent layer 136 is a transparent protecting layer. When the circuit structure layer 132 does not include the color filter film, the transparent layer 136 includes the color filter film. Moreover, in the embodiment of the flexible display apparatus 100 being the flexible EPD, the display medium layer 134 is the electrophoretic layer and the transparent layer 136 is a transparent protecting layer. In another embodiment, the circuit structure layer 132 may include a passive matrix and the peripheral circuit.

In the flexible display apparatus 100 of the present embodiment, the waterproof layer 110 is served as the substrate to prevent steam from permeating into the flexible display apparatus 100, so damage of circuits and devices of the flexible display apparatus 100 is avoided. Therefore, the flexible display apparatus 100 of present embodiment has better reliability.

FIG. 2 is a schematic view of a flexible display apparatus according to another embodiment of the present invention. Referring to FIG. 2, the flexible display apparatus 100′ of the present embodiment is similar to the flexible display apparatus 100 of FIG. 1, and the difference is that the flexible display apparatus 100′ further includes a plastic substrate 140. The plastic substrate 140 is disposed below the waterproof layer 110. In other words, in the flexible display apparatus 100′ of the present embodiment, the waterproof layer 110 is disposed on the plastic substrate 140 to prevent the steam from permeating into the flexible display apparatus 100′, so as to prevent the circuits and the devices of the flexible display apparatus 100′ from being damaged. Furthermore, material of the plastic substrate 140 includes, for example, polyimide.

FIG. 3 is a schematic view of a flexible display apparatus according to another embodiment of the present invention. Referring to FIG. 3, the flexible display apparatus 100″ of the present embodiment is similar to the flexible display apparatus 100′ of FIG. 2, and the difference is that the plastic substrate 140 of the flexible display apparatus 100″ is disposed between the waterproof layer 110 and the insulation layer 120. In other words, in the flexible display apparatus 100″ of the present embodiment, the waterproof layer 110 is disposed below the plastic substrate 140 to prevent the steam permeating into the flexible display apparatus 100″, so as to prevent the circuits and the devices of the flexible display apparatus 100″ being damaged.

In summary, the flexible display apparatus of the present invention at least has the following advantages:

1. The flexible display apparatus of the present invention has the waterproof layer which can prevent the steam from permeating into the flexible display apparatus, so damage of circuits and devices of the flexible display apparatus is avoided. Therefore, the flexible display apparatus of the present invention has better reliability.

2. In the embodiment of the material of the waterproof layer includes the PEEK, the waterproof layer can be formed by casting method. The casting method can effectively control the size of the waterproof layer under high temperature condition, so the size of the waterproof layer is stable.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A flexible display apparatus, comprising:
a waterproof layer, wherein material of the waterproof layer comprises organic compound;
an insulation layer disposed on the waterproof layer; and
a display unit disposed on the insulation layer.

2. The flexible display apparatus as claimed in claim 1, wherein the material of the waterproof layer comprises polyetheretherketone.

3. The flexible display apparatus as claimed in claim 2, wherein the waterproof layer is formed by casting method.

4. The flexible display apparatus as claimed in claim 1, wherein thickness of the waterproof layer is between 20 micrometers and 500 micrometers.

5. The flexible display apparatus as claimed in claim 1, wherein steam permeability of the waterproof layer is lower than 15%/meter square/day under 23 degrees centigrade and 100% relative humidity.

6. The flexible display apparatus as claimed in claim 1, further comprising a plastic substrate disposed between the waterproof layer and the insulation layer, or disposed below the waterproof layer.

7. The flexible display apparatus as claimed in claim 6, wherein material of the plastic substrate comprises polyimide.

8. The flexible display apparatus as claimed in claim 1, wherein the display unit comprising:
a circuit structure layer disposed on the insulation layer;
a display medium layer disposed on the circuit structure layer; and
a transparent layer disposed on the display medium layer.

9. The flexible display apparatus as claimed in claim 8, wherein the display medium layer comprises an electrophoretic layer or a liquid crystal layer.

10. A flexible display apparatus, comprising:
a waterproof layer, wherein thickness of the waterproof layer is between 20 micrometers and 500 micrometers;
an insulation layer disposed on the waterproof layer; and
a display unit disposed on the insulation layer.

11. The flexible display apparatus as claimed in claim 10, wherein steam permeability of the waterproof layer is lower than 15%/meter square/day under 23 degrees centigrade and 100% relative humidity.

12. The flexible display apparatus as claimed in claim 10, further comprising a plastic substrate disposed between the waterproof layer and the insulation layer, or disposed below the waterproof layer.

13. The flexible display apparatus as claimed in claim 12, wherein material of the plastic substrate comprises polyimide.

14. The flexible display apparatus as claimed in claim 10, wherein the display unit comprising:
a circuit structure layer disposed on the insulation layer;
a display medium layer disposed on the circuit structure layer; and
a transparent layer disposed on the display medium layer.

15. The flexible display apparatus as claimed in claim 14, wherein the display medium layer comprises an electrophoretic layer or a liquid crystal layer.

16. A flexible display apparatus, comprising:
a waterproof layer wherein steam permeability of the waterproof layer is lower than 15%/meter square/day under 23 degrees centigrade and 100% relative humidity;
an insulation layer disposed on the waterproof layer; and
a display unit disposed on the insulation layer.

17. The flexible display apparatus as claimed in claim 16, further comprising a plastic substrate disposed between the waterproof layer and the insulation layer, or disposed below the waterproof layer.

18. The flexible display apparatus as claimed in claim 17, wherein material of the plastic substrate comprises polyimide.

19. The flexible display apparatus as claimed in claim 16, wherein the display unit comprising:
a circuit structure layer disposed on the insulation layer;
a display medium layer disposed on the circuit structure layer; and
a transparent layer disposed on the display medium layer.

20. The flexible display apparatus as claimed in claim 19, wherein the display medium layer comprises an electrophoretic layer or a liquid crystal layer.
